(19) United States
(12) Patent Application Publication
(10) Pub. No.: US 2015/0302391 A1
(43) Pub. Date: Oct. 22, 2015

(54) METHOD FOR MAKING A PAYMENT USING A PORTABLE COMMUNICATION DEVICE

(71) Applicant: MOBILE PAYMENT SOLUTIONS HOLDING NORDIC AB, Solna (SE)

(72) Inventors: Christopher LINDFELDT, Solna (SE); Katarina LOWEBERG, Akersberga (SE)

(73) Assignee: Mobile Payment Solutions Holding Nordic AB, STOCKHOLM (SE)

(21) Appl. No.: 14/443,178

(22) PCT Filed: Nov. 14, 2013
(86) PCT No.: PCT/SE2013/051340

§ 371 Date: May 15, 2015

(30) Foreign Application Priority Data
Nov. 16, 2012 (SE) 1251301-6

(51) Int. Cl. G06Q 20/32; G06Q 20/20; G06Q 20/40

(52) U.S. Cl. CPC G06Q 20/3255; G06Q 20/3221; G06Q 20/4012; G06Q 20/202

(57) ABSTRACT

Method for making a payment using a portable communication device (110), wherein an SMS (Short Message Service) message (510;520) of a predetermined format, including a payment instruction with information (511;521) identifying a physical point of sale (100), and a product (101) or an amount, is sent from the device via a mobile phone network (111) to an SMS recipient (130,140), arranged to cause the payment to be executed. The method includes: providing first (140) and second (130) SMS recipients with different telephone numbers, the first causing the payment to be charged via a first payment service provider and the second causing the payment to instead be charged via a second payment service provider; and providing a computer software function arranged to automatically produce an SMS message of the type based upon parameter data available to the device, to select an SMS recipient, and send the SMS message.

The present invention relates to a method for making a payment using a portable communication device. More precisely, the payment is made based upon a payment instruction sent as a part of an SMS (Short Message Service) message from the portable communication device.

Many propositions have been made to solve the problem of cashless purchasing. Recently, it is becoming more common to use a portable communication device, such as a mobile cell phone, for performing payments during such purchasing. This is especially true for small amount payments.

Furthermore, it is known, for instance in the field of ticket purchasing for public transport, for a user to send an SMS message, with a predefined format, conveying a payment instruction.

It is also known to use a locally installed software application or a web site to send a payment instruction, over the Internet, to a transaction server which in turn charges the amount to a credit card or to a prepaid deposit.

WO 2005/029431 describes a method for paying for purchased products by sending an SMS, whereby an account of the buyer is charged for the payment.

US 2007/0255653 A1 describes a method for effecting mobile payments using a variety of different channels, among which SMS messages are one.

These known solutions suffer from a number of problems.

An SMS payment service is quite simple to use, but requires the user to obtain prior knowledge of the phone number to which the SMS message is to be sent, and of the format to use for the message. In some cases, the payment is charged directly to the phone bill of the user, which is convenient since the user then does not have to disclose any details regarding a credit card or the like. One drawback is, however that a user may not want to, or may not be allowed to, pay for a product when using a phone paid for by the user's employer.

An application or web service providing the possibility to charge a credit card or prepaid deposit, on the other hand, provides better flexibility. However, it is often perceived by the user as complicated and insecure to preregister a credit card or to prepay a certain amount to a deposit. Therefore, such services have seen limited commercial success to this date.

Another example would be to use other credit arrangements, such as bonus points awarded in some customer loyalty program or prepaid payment services that are not directly linked to a bank account but provided with funds in advance, to pay for a certain product.

However, using such alternative payment services to pay for a product typically involves some kind of login procedure using a web browser or the like, and is perceived as complicated by a user quickly wanting to purchase a product at for example a vending machine.

This is especially true in the case of unattended points of sale, where there is no possibility of communication with service personnel, and the user only has his or her portable communication device, such as a mobile telephone, to use to effect the payment.

The present invention solves these problems in that it provides a method for allowing a user to simplify the sending of a payment instruction while still making it possible to use a range of different payment service providers to carry out the payment transaction itself.

Hence, the present invention relates to a method for making a payment using a portable communication device, wherein an SMS (Short Message Service) message of a predetermined format, comprising a payment instruction, in turn comprising at least information identifying a physical point of sale, and information identifying a product to be purchased or a payment amount, is sent from the portable communication device via a mobile phone network to an SMS recipient, arranged to interpret SMS messages of the said predetermined format and to cause the payment to be executed, and is characterised in that the method comprises the steps of a) providing a first SMS recipient and a second SMS recipient, associated with different respective telephone numbers for receiving SMS messages, the first SMS recipient being arranged to, upon receipt of the said SMS message, cause the payment amount to be charged via a first payment service provider, and the second SMS recipient being arranged to, upon receipt of said SMS message, cause the payment amount to instead be charged via a second payment service provider, the second payment provider being different from the first payment provider; b) providing the portable communication device with a computer software function arranged to automatically produce an SMS message of the said type based upon parameter data available to the portable communication device; c) arranging the computer software function to, based upon the said parameter data, select as SMS recipient one of the first and the second SMS recipients; and d) sending the produced SMS message to the selected SMS recipient.

In the following, the invention will be described in detail, partly with reference to the appended drawings, in which:

FIG. 1 is an overview illustration of a system for performing a method according to the present invention;

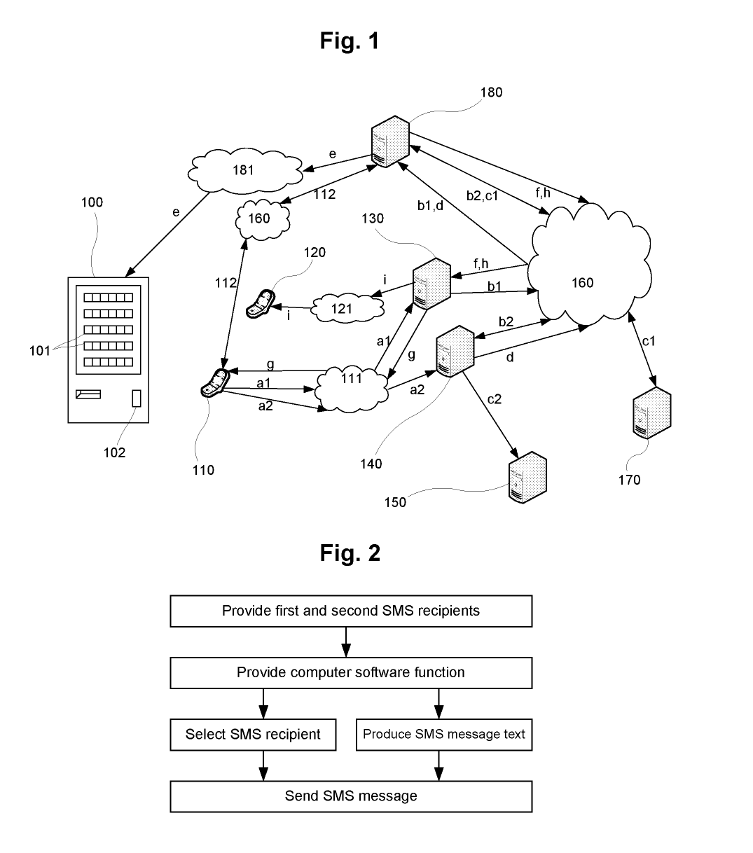

FIG. 2 is a flowchart illustrating a method according to the present invention;

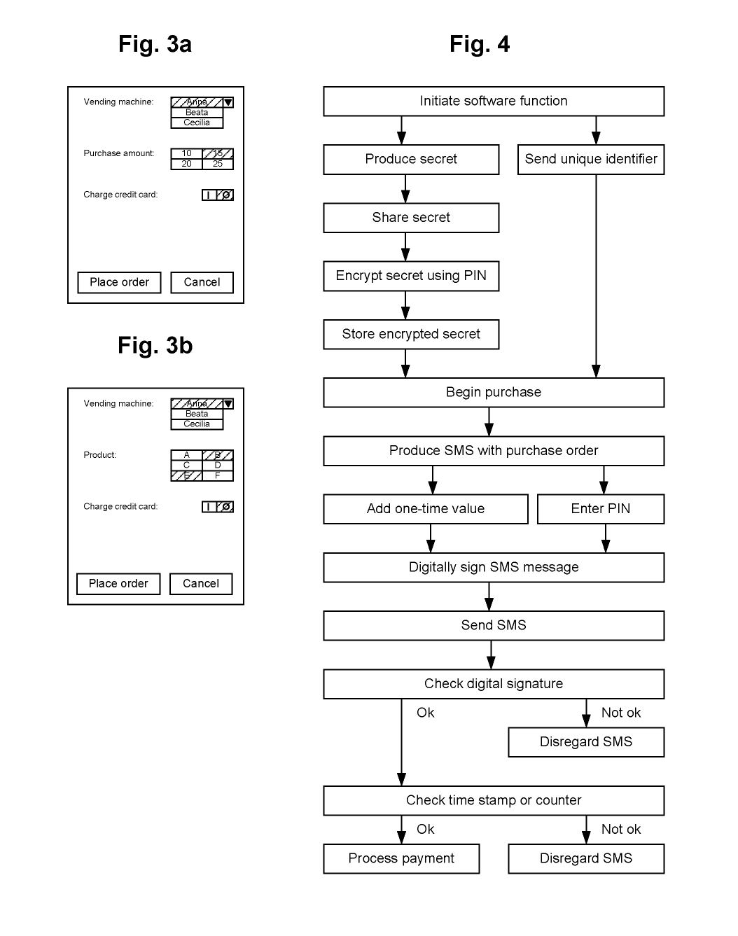

FIGS. 3a and 3b each shows a respective graphical user interface presented to the user of a portable device software function according to the invention;

FIG. 4 is a flowchart illustrating method steps according to the invention for digitally signing an SMS message; and

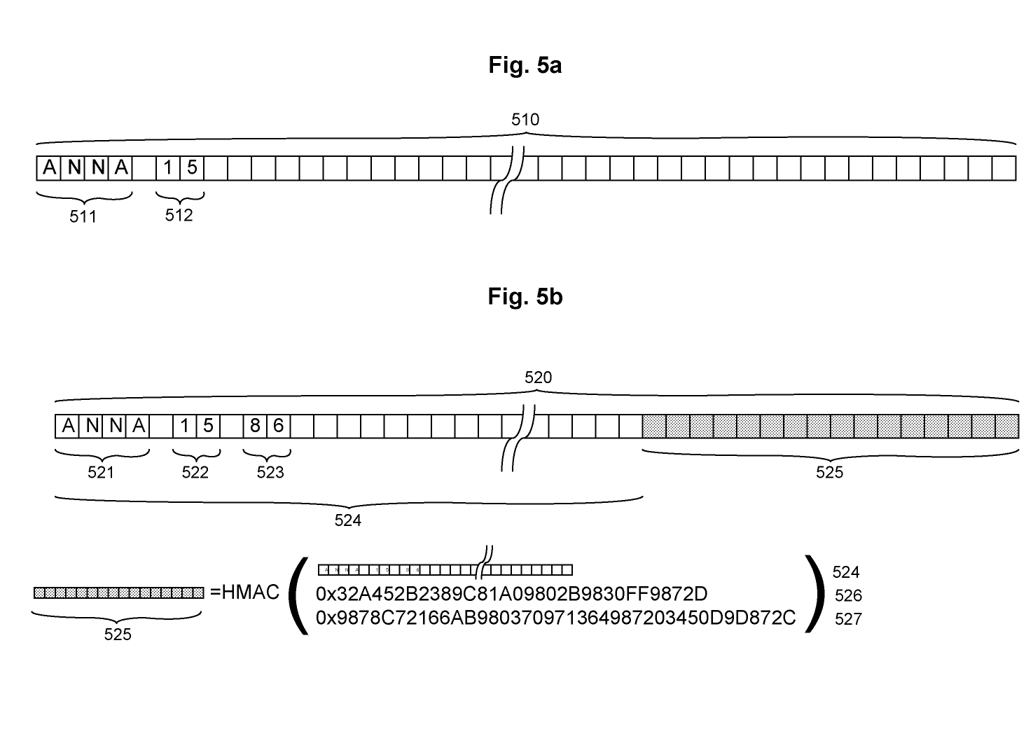

FIGS. 5a and 5b illustrate two different exemplary SMS messages according to the present invention, wherein FIG. 5b also shows the calculation principle for a digital signature according to the invention.

Hence, FIG. 1 illustrates a system suitable for performing a method according to the present invention.

A point of sale 100 is illustrated by way of example as a vending machine, comprising products 101 on sale and a GSM module 102 for communicating via SMS messages.

The point of sale 100 is a physical point of sale, such as the counter of a shop or the staffed cashier of a ticket vendor. It is especially preferred that the point of sale is a point of sale with no wired Internet access, such as may be the case of an automatic vending machine positioned in a public space. In that case, it is preferred that the point of sale is connected via a wireless network, such as wireless Internet or more preferably a mobile phone network such as a GSM network, to a server 180 in order to receive information.

In particular, it is preferred that the point of sale 100 is a physical unattended point of sale, in other words it is a fully automated purchasing station without any sales staff being physically present during the purchase. In this case, the invention provides a simple way for a user to use a wide range of payment options without having to enter into a dialog with such sales staff. In the following, the invention is described in terms of a vending machine being the point of sale 100, but it is realized that the invention is analogously applicable to other physical types of point of sales, as exemplified above.

A portable communication device 110, such as a mobile telephone featuring a general-purpose programmable operating system, is preferably carried by a user or purchaser to within geographic proximity of the point of sale 100 from which the user wants to purchase one or several products. The communication device 110 is connected to a mobile phone network 111, such as a GSM network, provided by the user's mobile phone operator.

Similarly, a second portable communication device 120, which can be of a type similar to that of device 110, is connected to a second mobile phone network 121 provided by the mobile phone operator of a second user, of device 120. It is realized that networks 110, 120 can be the same in case both users use the same operator.

Two SMS recipients 130, 140, in other words servers capable of receiving SMS message data delivered in the mobile phone network, are connected to networks 111, 121. SMS recipient 140 is in turn connected, for instance via a LAN or the like, to a telephone bill handling system 150.

SMS recipients 130, 140, as well as an external bank account handling server 170 and a vending machine management server 180, are connected to each other over a wide area network 160, such as the Internet. The device 110, in particular the software function operable thereon, is also in contact 112 with server 180 via the wide area network 160, for instance via GPRS (General Packet Radio Services) or WiFi.

The vending machine management server 180 is, finally, connected to the GSM module 102 of vending machine 100 as described above, using another mobile telephone network 181, which may or may not be the same as network 111 and/or 121.

A user arriving at, and wanting to purchase one or several items 101 from the vending machine 100 will have to pay for said items. According to the invention, the payment is cashless, in other words it is executed remotely, without the user having to physically provide a carrier of value, such as coins, bills, a physical credit card or the like to the machine.

Hence, according to the invention, an SMS message, comprising a payment instruction covering the desired items, is sent from the portable communication device 110 to network 111. In order for the recipient of the payment instruction to have knowledge of the amount to be charged to the user, the SMS message comprises information comprising the payment amount. Alternatively, the SMS message can comprise information identifying one or several of the items 101 to be purchased, in which case the payment amount is determined centrally, for instance by server 180, based upon current stocking and pricing information regarding the items carried by the vending machine 100. The SMS message also comprises information identifying the point of sale 100.

According to the invention, the SMS message is sent from the portable communication device 110, via the mobile phone network 111, to an SMS recipient arranged to interpret SMS messages of the above described type, comprising the said identifying information.

Further, the SMS recipient to which the SMS message is sent is arranged to cause the payment to be executed, in other words the SMS recipient is directly or indirectly, via possibly a server such as server 180 and a connected payment service provider, arranged to provide for the payment in question to be carried out. That the SMS recipients are arranged to “cause the payment to be executed” is herein hence not intended to mean that the SMS recipient as such necessarily directly takes care of the payment. Rather, not least since an SMS recipient of the type described herein may be an integral part of an operator's mobile network hardware, the SMS recipient is arranged to act upon the reception of an SMS message in a way which ultimately leads to the payment of the amount. What is important is that the payment is carried out in different ways as a consequence of the reception of SMS messages of at least two different SMS recipients.

It is further essential for the achievement of the present purposes that the device 110 is capable of selectively sending the SMS message to one of at least two such SMS recipients 130, 140. According to the invention, the recipients 130, 140 are associated with different respective telephone numbers for receiving SMS messages.

According to the invention, the first SMS recipient 140 is arranged to, upon receipt of the SMS message, cause the payment amount to be charged via a first payment service provider, such as the telephone bill handling system 150. The second SMS recipient 130 is, however, arranged to, upon receipt of the SMS message, cause the payment amount to instead be charged via a second payment service provider, such as the external bank account handling server 170. According to the invention, the second payment provider is different from the first payment provider.

According to a preferred embodiment, at least one 140 of the SMS recipients is arranged to, upon receipt of the said SMS message, cause the payment amount to be charged to the telephone subscription used for sending the SMS message. Hence, if the SMS message is sent to SMS recipient 140, the purchase amount, together with any service charges, will be charged to the mobile telephony bill of the user of device 110.

Moreover, according to a preferred embodiment, at least one 130 of the SMS recipients is arranged to, upon receipt of the SMS message, cause an amount to instead be charged to a predetermined bank account.

As is clear from FIG. 2, after providing the first and second SMS recipients, the portable communication device 110 is provided with a computer software function. Thereafter, in parallel or in sequence, the software function is arranged to on the one hand select as SMS recipient for the currently handled SMS message one of the at least two SMS recipients 130, 140, and, on the other hand, to automatically produce the SMS message (see below). The said selection and production are both based upon parameter data available to the portable communication device 110. The different types of parameter data includes, but is not limited to, the above discussed information regarding payment amount/products and the identity or other information regarding the point of sale. Other examples of parameter data of possible use for the selection of SMS recipient include geographical location of the device 110 or the point of sale; time of day and/or day of week; any specific instructions received from the server 180 to the software function via connection 112 regarding any convenience fees applicable, promotions or campaigns; direct user selection; and so on.

Finally, the software function is arranged to send the produced SMS message to the selected SMS recipient 130 or 140. This is done by simply sending the SMS message to the telephone number associated with the selected SMS recipient, via the normal SMS channel over the mobile phone network 111, for instance using the native SMS client of the device 110.

The computer software function may be a locally installed software program on the device 110, a web service accessible via an Internet browser application installed in the device 110, or a combination thereof. It is preferred that the software function comprises at least some computer code running on the device 110, for instance in order to carry out the below described storing of encryption data and calculation of digital signatures relating to the data security functionality aspects of the produced SMS message. Preferably, the software function is implemented as a standalone application runnable on the device 110. The Internet connection can be conventional as such, such as a WWAN or WIFI connection.

Since the said software function automatically selects the phone number to which the SMS message is sent based upon parameter data known to the software function locally in the portable communication device 110, the flexibility as to how the charging is carried out will be greatly enhanced as compared to conventional SMS purchasing. Different SMS recipients may be operated by different parties, such as a mobile operator, and will therefore be associated with varying models with respect to charging and billing. For instance, at least two SMS recipients may be set up, each with a different or no surcharge applied by the operator to the reception of an SMS message. Moreover, for some SMS recipients the payment may be automatically performed by debiting the SMS sender's bill, while not for others. Some SMS recipients may be connected to various external providers of banking services or products to be purchased. Some SMS recipients may be arranged to cause the payment to be executed using different types of payment service providers using funds not directly tied to a bank or credit account, such as using customer loyalty points; virtual currency used in electronic communities such as social media; gift vouchers; coupons, and so on.

The payment service operator can hence set up a range of different SMS message recipients, each providing a desired payment functionality, while the selection of payment functionality can be performed automatically, without the device 110 user having to be knowledgeable about what telephone number to use in what circumstance.

Furthermore, a method according to the present invention allows for a separation between a product supplier/seller and a payment solution provider while still providing an uncomplicated way to use the SMS channel for payment instructions, and specifically providing the possibility for telephone bill charging.

Specifically, different payment service providers may have previously entered agreements with certain telephone operators, requiring an SMS based payment to take place via an SMS sent to a certain SMS recipient. Also, there may be legal restriction as to choice of SMS recipient, convenience fee charging, etc., affecting the possibilities.

According to a preferred embodiment, after receipt of the SMS message, the payment instruction information comprised in the received SMS message is sent from the selected SMS recipient 130, 140 to the central server 180, which in this case is the same central server for both SMS recipients 130, 140. The server 180 is arranged to interpret the payment instruction comprised in the SMS message, by reading a predefined message formatting like the one detailed below, and then to communicate, possibly via the selected SMS recipient 130, 140, the payment instruction to the first 150 or the second 170 payment service provider, depending on which SMS recipient was selected. In other words, a single central server 180 is used to interpret the actual SMS message contents and to provide the relevant payment service provider with information regarding the payment, such as amount, payer and payee. This way, the selection of payment service provider and the execution of the actual payment can be made completely automatic by the portable device software function, without the user having to bother about any login credentials, Internet site addresses or the like.

As illustrated in FIG. 2, in a step a1 or, alternatively, a2, the device 110 sends the SMS message to either SMS recipient 130 or SMS recipient 140.

In the case of a1, recipient 130 sends, in step b1, the payment instruction included in, or corresponding to, the received SMS message, via the Internet 160, to server 180. In reaction thereto, server 180 sends, in step c1, the payment instruction to the bank account handling server 170, which then executes the payment for instance by charging a credit or debit card (using for instance a so called securely stored card for recurring payment), or a bank account, associated with the user. Herein, these types of cards and accounts are collectively denoted “bank accounts”, which term is intended to cover all types of financial arrangements capable of being charged for a purchase, such as debit and credit cards as well as deposit accounts. Server 170 responds to server 180 with a transaction result, which is negative if for instance insufficient funds were available.

In the case of step a2, recipient 140 sends, in step b2, information to server 180 with the contents of the received SMS message. Server 180 responds to recipient 140 with an instruction to charge the relevant amount. In response hereto, recipient 140 instructs, in step c2, the telephone bill handling system 150 to place the payment amount as an addition on the user's telephone bill for the SMS sending telephone number. Then, the SMS recipient 140 sends, in step d, information regarding the payment, preferably comprising information regarding the success of the payment, to server 180. It is preferred that the server 180, in case the payment was unsuccessful, due to lack of funds or for any other reason, sends a reply SMS to the device 110 with information about the abort of the purchase. This is possible since the server 180, via recipients 130, 140, has gained knowledge about the telephone number of the device 110 as a consequence of the received SMS message.

The server 180 is then arranged to, upon the reception by the selected respective SMS recipient 130, 140 of the SMS message and the execution of the payment, send, in step e, an instruction to the vending machine 100, comprising either a credit amount or an identification of one or several products for which payment has been duly made. The vending machine 100 then makes available to the user the selected products in question or a possibility for the user to select products to a total cost according to the payment amount. Analogously, if the purchase was made in a shop or the like, the products would now be eligible for delivery to the user.

Thereafter, the server 180 sends, in step f, an instruction to SMS recipient 130, which in turn sends a receipt SMS message, in step g, to device 110. Both the said receipt SMS message and the above discussed payment error SMS message may be sent via server 130 or using another, not shown, SMS service provider.

According to a preferred embodiment, the server 180 may, instead or in addition to step e, then, in a step h performed in response to the receipt of the sent SMS message by the SMS recipient, send a message to SMS recipient 130, or any other connected server capable of sending SMS messages to subscribers to mobile phone network 121, with instructions to send an SMS message comprising a digital voucher or indication of a credit to a receiver 120 of the purchased product, which voucher or credit corresponds to the purchased product or amount and is valid for a purchase at the point of sale 100. In a step i, the SMS message is sent to the receiver 120.

It is then preferred that the receiver 120 of the product is a mobile phone subscriber different from that of device 110, in the form of a voucher or indication of credit. The telephone number or other identity of receiver 120 may be provided via the software function from the device 110.

According to a preferred embodiment, the software product comprises an interface, preferably a graphical user interface, via which the user of the portable device 110 can set one or several parameters pertaining to the purchase.

FIG. 3a shows a first example of such an interface, presenting the user with an option as to what point of sale to use for the purchase, in this exemplary case one of three available different vending machines named “Anna”, “Beata” and “Cecilia”. It is preferred that the user may explicitly state an identifier of a point of sale by which the user is located. Also, a list such as the one presented in FIG. 3a may be presented to the user, for selection. Preferably, a location function, such as a GPS receiver module, in the device 110 is used to identify the one or several most closely located supported point of sales, which information may be supplied to the device via connection 112. Furthermore, the user may be presented a list of recently used points of sale, or any combination of such selection principles.

FIG. 3a also shows that the user can select a payment amount, preferably from a number of predetermined amounts depending on the products on offer at the point of sale and possibly subject to an upper limit for the total amount.

FIG. 3b shows an alternative user interface, wherein the user can instead choose one or several of a selection of products on sale at the point of sale. The information regarding prices and products may, again, be obtained via connection 112, and depending on the selected point of sale. The server 180 would be able to obtain the information either indirectly, via the logistics function used to refill the vending machine 100, or directly, from the machine 100 itself, via network 181.

Furthermore, as shown in FIGS. 3a and 3b, the user can indicate whether the amount should be charged from the telephone subscription bill or from a predetermined bank account. According to a preferred embodiment, the SMS recipient 130, 140 is selected by the software function based upon the value of this parameter. This way, the user may conveniently select the payment method. The next time the user makes a purchase, the same setting may be used with no need to choose each time.

However, according to another preferred embodiment, the SMS recipient 130, 140 is selected by the software function completely automatically based upon parameter data which is available without the user having to make a selection. For instance, different points of sale may be associated with different SMS recipients 130, 140, based for example upon information received by the software function from server 180, such that a user can be charged via the telephone bill when purchasing products at points of sale located at the user's work place, but the credit card can be charged while off duty.

Other examples include that what SMS recipient 130, 140 is selected depending upon the current geographic location of the user as measured by the device 110, using GPS (Global Positioning System) receiver or otherwise, or upon the current time of day and/or day of week.

Yet other examples include the SMS message being addressed to the SMS recipient 130 first, in an attempt to fund the purchase from a bank account, and, given that there are insufficient funds on the account, another SMS message would be sent to the recipient 140 and the purchase amount charged via the telephone bill instead.

Moreover, temporary price changes, such as during campaigns, can be conveniently implemented by temporarily instructing the software function to use a certain alternative SMS recipient during a specific time period.

In order to achieve the association between server 180 and account handling server 170, the user needs to beforehand supply the details of a bank account, a credit card or the like to the system. This can be done in any suitable conventional manner, but according to a preferred embodiment the user interface of the software function allows for the user to, in an initial, one-time step before ordering a first payment for account charging, supply such details to the SMS server 180, preferably over a trusted communication protocol, such as HTTPS, via connection 112, and preferably using asymmetric key encryption to protect the secrecy and integrity of the sensitive data.

Using the SMS channel according to the above provides relatively high security standards even if the payment instruction itself is sent in unprotected, plain text format, such as comprised in an unencrypted SMS message body. This is because there is no continuous communication connection established between the device 110 and the SMS recipient 130, 140, and also because no information of real sensitivity is transferred over the SMS channel. Via for instance SMS recipients 130, 140 and server 180, high security standards may be employed, in a manner which is conventional as such.

However, according to a preferred embodiment, illustrated in FIG. 4, the SMS messages are digitally signed before being sent. First, the software function is initiated or installed. Then, in step which is preferably performed in connection to the setup of the software function, alternatively upon initiation of the software function or in connection to the production of an SMS message, a central server in the system, such as server 180, produces a secret. The secret is then, in a subsequent step, shared to both the portable communication device and an SMS interpreting device arranged to interpret SMS messages received by one of the said SMS recipients. For reasons of simplicity, in the embodiment illustrated in FIG. 1, the SMS interpreting device is in the form of a respective software module running on each of the SMS recipients 130, 140, even if it is realized that a separate SMS interpreting device can be arranged to communicate with SMS recipients 130, 140 for interpreting received SMS messages, or that the SMS interpreting device is a software function running on server 180.

The received shared secret is then stored by the software product in a memory on the portable communication device 110 in encrypted form. A PIN code, which preferably is selected by the user, is used by the software product as the encryption key for encrypting the shared secret.

In parallel or sequence to the steps handling the shared secret, a unique identifier of the portable communication device 110 is sent to the said SMS interpreting device. The unique identifier thus uniquely, or with sufficient uniqueness to essentially rule out the possibility of two portable communication devices connected to the system having the same identity, identifies the portable communication device 110 as such, as opposed to for instance a SIM (Subscriber Identity Module) card of the device 110. Preferred such identifiers comprise the so called UDID (Unique Device IDentitifier) or the IMEI (International Mobile Equipment Identity), uniquely identifying the actual hardware of device 110.

All the above described steps of FIG. 4 can be performed ahead of any actual purchases.

At the time of producing the SMS message in order to send a payment instruction for a product to be purchased, the software function first produces a basic, unsigned SMS with payment order information, such as is exemplified in FIG. 5a. Thereafter, the software function preferably adds, to the unsigned produced SMS message, a one-time value, which may only be used one time in a certain time period by one and the same device 110, such as a time stamp or a counter, which counter is modified by the software product for each produced SMS message, for instance by being incremented.

Then, the software function digitally signs the SMS message before sending it, using a digital signature. In particular, a condensed, irreversibly digested piece of information is calculated based upon the contents of the SMS message body, and is then appended to the SMS message before it is sent. Preferably, the digital signature is calculated using a hash function, which preferably has both the above described shared secret and the above described unique identifier as input parameters, apart from the message body itself. Suitable algorithms for calculating the digital signature for example comprise the well-known family of HMAC algorithms.

In order to decrypt the shared secret, the user is first prompted to enter the PIN code before the SMS message is produced, and the software product uses the PIN code to decrypt the shared secret before digitally signing the SMS message.

After being signed, the SMS message is sent, upon the reception of which the above described SMS interpreting device checks the digital signature against the SMS message text, using the previously received and since then stored unique identifier, as well as the shared secret. If the digital signature is not according to expectations, the SMS message is discarded and the method stops. Subsequently, the value of the one-time value is checked against previously used, stored time stamp or counter values. If the time stamp or counter is found to be new, the SMS message is processed as described above. If the one-time value was already used in a previously received SMS message from the same device 110, the SMS is disregarded and the method stops. It is realized that the two checks can be made in any order, since the one-time value is sent in plain text.

Since the SMS message text is digitally signed, the SMS recipient 130, 140 will know whether the plain-text payment instruction containing SMS message text has been modified after the production of the SMS by the software function, and will only deal with SMS messages the integrity of which is kept intact. Therefore, so called man-in-the-middle attacks are avoided. Also, the user is prevented from manually sending SMS messages without using the software function. This is desirable, since for instance a seller, an employer or another interested party will sometimes want to control the possible charging paths for a certain user.

Since the non-tampered SMS message contains a time stamp or a counter, an SMS message can only be validly sent once. This prevents unauthorized copying of SMS messages.

It is furthermore preferred that an identifier of the user's subscription, such as the MSISDN (Mobile Subscriber Integrated Services Digital Network number) is used by the SMS recipient 130, 140 for identifying the sender of the SMS message for purchase purposes, since then it will not be possible to continue purchasing products using a stolen portable device with a new SIM card.

FIG. 5a illustrates an exemplary SMS message 510 without a digital signature and with no time stamp or counter. However, it includes the name 511 (“ANNA”) of a vending machine from which the user whiskies to purchase a product, and an amount 512 (“15”) to be purchased for. The SMS message is maximally 160 characters long in total.

FIG. 5b illustrates a similar SMS message 520, featuring a name 521 and an amount 522, but also a one-time value in the form of a counter 523 (“86”) and a digital signature 525. The digital signature 525 is 16 bytes long and marked using gray blocks.

As is illustrated in FIG. 5b, the digital signature 525 is calculated as a digest, using a HMAC function, of the rest of the message body 524, the 128 bit shared secret 526 and the 160 bit UDID 527 of the portable device 510.

Above, preferred embodiments have been described. However, it is obvious to the skilled person that many modifications may be made to the described embodiments without departing from the basic idea of the invention.

For instance, more than one SMS recipient may be selectable by the software function, to reflect various charging paths and methods.

Furthermore, a user may also, as an alternative to being charged, select to use for instance a gift certificate to pay for the products. In this case, a payment order referring to the gift certificate may be sent via an SMS in a manner similar to the one described above.

As regards the infrastructure shown in FIG. 1, there are several possible modifications. For instance, the server 180 may be split up in a central server part, handling the communication with SMS recipients 130, 140 and such, and a local server part, communicating with one or several point of sales 100.

The purchased product can be of any kind, such as one or several goods or services, or a combination.

Thus, the invention is not limited to the described embodiments, but may be varied within the scope of the enclosed claims.

1-11. (canceled)

12. Method for making a payment using a portable communication device (110), wherein an SMS (Short Message Service) message (510;520) of a predetermined format, comprising a payment instruction, in turn comprising at least
information (511;521) identifying a physical point of sale (100), and
information (512;522) identifying a product (101) to be purchased or a payment amount,
is sent from the portable communication device (110) via a mobile phone network (111) to an SMS recipient (130,140), arranged to interpret SMS messages of the predetermined format and to cause the payment to be executed, wherein the method comprises the steps of
a. providing a first SMS recipient (140) and a second SMS recipient (130), associated with different respective telephone numbers for receiving SMS messages, the first SMS recipient (140) being arranged to, upon receipt of the SMS message (510;520), cause the payment amount to be charged via a first payment service provider (150), and the second SMS recipient (130) being arranged to, upon receipt of said SMS message (510;520), cause the payment amount to instead be charged via a second payment service provider (170), the second payment provider being different from the first payment provider;
b. providing the portable communication device (110) with a computer software function arranged to automatically produce an SMS message of the type based upon parameter data available to the portable communication device (110);
c. arranging the computer software function to, based upon the parameter data, select as SMS recipient one of the first (140) and the second SMS recipients (130); and
d. sending the produced SMS message (510;520) to the selected SMS recipient.

13. Method according to claim 12, wherein the first SMS recipient (140) is arranged to, upon receipt of the SMS message (510;520), cause the payment amount to be charged to the telephone subscription used for sending the SMS message (510;520).

14. Method according to claim 12, wherein the second SMS recipient (130) is arranged to, upon receipt of said SMS message (510;520), cause the payment amount to instead be charged to a predetermined bank account.

15. Method according to claim 12, wherein, after receipt of the SMS message (510;520), the payment instruction information comprised in the received SMS message is sent from the selected SMS recipient (140,130) to a central server (180) which is the same central server for both SMS recipients, which central server further interprets the payment instruction comprised in the SMS message and communicates, possibly via the selected SMS recipient, the payment instruction to the first (150) or the second (170) payment service provider, depending on which SMS recipient was selected in step d).

16. Method according to claim 12, wherein the product (101) is purchased from the physical point of sale (100), which is an unattended point of sale.

17. Method according to claim 16, wherein, upon the reception by the selected SMS recipient (130,140) of the SMS message (510;520) and the execution of the payment, an instruction is sent to the point of sale (100), comprising either a credit amount or an identification of said product (101).

18. Method according to claim 12, wherein the software product is caused to comprise an interface via which a user can set a parameter indicating whether the amount should be charged from the subscription or from a predetermined bank account, and the SMS recipient (130,140) is selected based upon the value of this parameter.

19. Method according to claim 12, wherein the SMS recipient (130,140) is automatically selected by the software product based upon information regarding the identity of the physical point of sale (100), alternatively upon a current geographic location of the portable communication device (110) as measured using a geographic location measuring means of the portable communication device (110).

20. Method according to claim 12, wherein in an initial step, a secret (526) is generated by a central server (180), and shared with both the portable communication device (110) and an SMS interpreting device arranged to interpret SMS messages received by one of the SMS recipients (130,140); a unique identifier (527) of the portable communication device (110) is sent to the SMS interpreting device; the software product digitally signs the SMS message (520) before sending it using a digital signature (525) which is calculated using a hash function with the shared secret (526) as well as the unique identifier (527); and the SMS interpreting device checks the digital signature and discards the received SMS message (520) if the digital signature (525) is incorrect.

21. Method according to claim 20, wherein the unsigned produced SMS message (524) contains a one-time value (523), and the SMS interpreting device discards the received SMS (520) if the same one-time value is used twice.

22. Method according to claim 20, wherein the shared secret (526) is stored in a memory on the portable communication device (110) in encrypted form by the software product; a PIN code is used by the software product as the encryption key for encrypting the shared secret (526); a user of the portable communication device (110) is prompted to enter the PIN code before the SMS message (520) is produced; and the software product uses the PIN code to decrypt the shared secret (526) before digitally signing the SMS message (520).
